(19) United States
(12) Patent Application Publication
(10) Pub. No.: US 2015/0079547 A1
(43) Pub. Date: Mar. 19, 2015

(54) SYSTEMS AND METHODS FOR PROVIDING AN INTERIOR DESIGN DISPLAY

(71) Applicant: Jay L. Moss, North Salt Lake, UT (US)

(72) Inventor: Jay L. Moss, North Salt Lake, UT (US)

(21) Appl. No.: 14/333,253

(22) Filed: Jul. 16, 2014

Related U.S. Application Data
(60) Provisional application No. 61/872,600, filed on Aug. 30, 2013.

(51) Int. Cl. G09B 25/08

(52) U.S. Cl. CPC G09B 25/08
USPC 434/98

(57) ABSTRACT

Some implementations relate to an interior design display configured to help individuals select matching materials for interior design. While the display can include any suitable component, in some cases, it includes multiple style displays (wherein each style display includes information relating to a separate style of interior design) and a first and a second separate and moveable sample panel for each of the style displays. In such cases, the first and second separate and moveable sample panels for each of the style displays each includes design element samples corresponding to the style of interior design relating to the corresponding style display. Additionally, in some cases, all design element samples from the first sample panels for each of the style displays match with each other, and all design element samples from the second sample panels for each of the style displays match with each other. Other implementations are described.

### CROSS-REFERENCE TO RELATED APPLICATION

This application claims priority to U.S. Provisional Patent Application Ser. No. 61/872,600, filed Aug. 30, 2013, and entitled “SYSTEMS AND METHODS FOR PROVIDING AN INTERIOR DESIGN DISPLAY;” the entire disclosure of which is hereby incorporated by reference.

### BACKGROUND OF THE INVENTION

1. Field of the Invention

The present invention relates to interior design. In particular, some implementations of the present invention relate to systems and methods for providing an interior design display that is configured to help its users choose one or more design elements from one or more interior design styles and to help ensure that the chosen design elements match or otherwise coordinate with each other.

2. Background and Related Art

The art of interior design often involves designing and coordinating color schemes, design elements, fittings, decorations, architectural features, construction materials, and/or furnishings for an interior space (e.g., a home, office, etc.) to turn the interior space into a proper setting for one or more of a variety of human activities. In some cases, interior design is performed by professional individuals or firms that are hired to coordinate the interior design of a desired interior space. In other instances, however, individuals (e.g., consumers) choose to do their own interior design.

Where a professional interior designer (or decorator) coordinates the design of an interior space, the designer may be able to offer several beneficial services. For instance, the professional designer may be able to save a consumer's time, properly match a variety of design elements in the desired interior space, provide the interior space with a professionally-designed and aesthetically-pleasing look, and/or create a look and feel that is better than the consumer had time or the ability to create. Notwithstanding the foregoing, the use of professional designers is not necessarily without its shortcomings. By way of example, some professional interior designers can be relatively expensive to hire, hard to work with, and/or may have a hard time properly capturing the consumer's desired look for a specific interior space.

Additionally, while some consumers or other individuals are able to do a great job on their own interior design projects, others lack the ability (or time) to properly match and coordinate design elements. Indeed, in many cases, individuals lack the education, creativity, vision, matching capability, and/or know-how needed to furnish an interior space with a professional-quality look and style.

Thus, while techniques currently exist that are used to design interior spaces, challenges still exist. Accordingly, it would be an improvement in the art to augment or even replace current techniques with other techniques.

### SUMMARY OF THE INVENTION

The present invention relates to interior design. In particular, some implementations of the present invention relate to systems and methods for providing an interior design display that is configured to help its users choose one or more design elements from one or more interior design styles and to help ensure that the chosen design elements match or otherwise coordinate with each other.

Implementation of the present invention takes place in association with an interior design display. While the design display can include any suitable component, in some cases, it includes multiple style displays (which each provide information relating to a particular style of interior design, such as a classic style, an eclectic style, etc.) and a first (e.g., a warm color palette) and a second (e.g., a cool color palette) design element sample collection for each of the style displays. In such cases, the first and second sample collections for each of the style displays each include a variety of design element samples (e.g., pictures and/or pieces of design elements) that correspond to the interior design style of the collections' corresponding style display. Additionally, in some cases, all design element samples from the first design sample collections for each of the style displays match with each other, and all design element samples from the second design sample collections for each of the style displays match with each other. Furthermore, in some embodiments, at least some of the design element samples from the first design sample collection to not match all of the design element samples from the second design element collection.

In other implementations, the interior design display includes a first style display comprising information regarding a first style of interior design; a second style display comprising information regarding a second style of interior design; a first design element sample collection (or sample collection) comprising a first classification of design element samples corresponding to the first style of interior design; a second sample collection comprising a second classification of design element samples corresponding to the first style of interior design; a first design element sample collection comprising a first classification of design element samples corresponding to the second style of interior design; and a second sample collection comprising a second classification of design element samples corresponding to the second style of interior design, wherein all of the first classification of design element samples from the first sample collection comprising the first classification of design element samples corresponding to the first style of interior design match all of the first classification of design element samples from the first sample collection comprising the first classification of design element samples corresponding to the second style of interior design, and wherein all of the second classification of design element samples from the design element second sample collection comprising the second classification of design element samples that correspond to the first style of interior design match all of the second classification of design element samples from the second sample collection comprising the second classification of design element samples that correspond to the second style of interior design.

In yet other implementations, the described systems and methods comprise one or more electronic displays (e.g., TV, monitors, projector, etc.), wherein at least one of the displays is configured to function as a style display (e.g., to provide images of, a description of, and/or other information about or relating to a particular style of interior design). Although in some implementations, one or more physical design element sample collections are provided in connection with the display, in some implementations, the display is configured to show images of at least some design element samples. In some cases, the electronic display is further configured such that design element samples from multiple design styles shown through (or along with) the electronic display(s) will match with each other as long as such design element samples are from the same classification of design element samples (e.g., a warm or a cool classification).

Still other implementations of the described invention relate to a method for providing interior design choices. In some such implementations, the described methods include providing an interior design display comprising: multiple style displays, wherein each style display comprises information relating to a separate style of interior design; and a first and a second sample panel (or design element sample collection) for each of the style displays, wherein the first and second sample panels for each of the style displays each comprise design element samples corresponding to the style of interior design relating to the corresponding style display. In some implementations, the described methods further include ensuring that all of the design element samples from the first sample panels for each of the style displays match with each other, and ensuring that all of the design element samples from the second sample panels for each of the style displays match with each other.

While the described methods and processes may be particularly useful in the area of designing the interior of homes and other residential spaces, those skilled in the art will appreciate that the described methods and processes can be used in a variety of different applications and in a variety of different areas of manufacture to design the interior of virtually any desired interior space, including, without, limitation, virtually any office space, retail space, and/or space in any other suitable room or building. Additionally, while this description focuses on using the described interior design display in connection with the design of interior spaces, the skilled artisan will recognize that the described display can be used in the design of any other suitable area, including, without limitation, any suitable patio, deck, arboretum, and/or other space that is at least partially disposed outside.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1A illustrates a front elevation view of a representative embodiment of an interior design display;

FIG. 1B illustrates a side view of the interior design display of FIG. 1A;

FIG. 2A illustrates a front elevation view of a representative embodiment of a sample panel;

FIG. 2B illustrates a side view of a portion of a representative embodiment of the sample panel;

FIG. 3A illustrates a front elevation view of a representative embodiment of the interior design display;

FIG. 3B illustrates a top plan view of the interior design display of FIG. 3A;

FIG. 4A illustrates a side elevation view of a representative embodiment of a style display;

FIG. 4B illustrates a side cross-sectional view of a representative embodiment of the style display;

FIG. 4C illustrates a side elevation view of a the interior design display of FIG. 3A;

FIGS. 4D-4F each illustrate a front elevation view of a representative embodiment of the style display;

FIG. 5A illustrates a front elevation view of a representative embodiment of the style display when opened;

FIG. 5B illustrates a front elevation view of a representative embodiment of the style display when closed;

FIG. 5C illustrates a side elevation view of a representative embodiment of the style display when closed;

FIG. 6A illustrates a front elevation view of a representative embodiment of the sample panel;

FIGS. 6B-6C each illustrate a side elevation view of a different representative embodiment of the sample panel;

FIG. 6D illustrates a side elevation view of a portion of the sample panel shown in FIG. 6C;

FIG. 7A illustrates a front elevation view of a representative embodiment of the interior design display;

FIG. 7B illustrates a side cross-sectional view of the interior design display of FIG. 7A;

FIG. 7C illustrates a top cross-sectional view of the interior design display of FIG. 7A;

FIGS. 8A-8D each illustrate a front elevation view of a representative embodiment of a sample board;

FIGS. 9A-9L illustrate a variety of views of representative embodiments of cabinets for use with the interior design display;

FIG. 10 illustrates a front elevation view of a representative embodiment of a cabinet for use with some embodiments of the system;

FIG. 11 illustrates a side cross-sectional view of a representative embodiment of the sample panel;

FIG. 12A-12C illustrate various view of a representative embodiment of a header;

FIG. 13 illustrates a representative system that provides a suitable operating environment for use with some embodiments of the present invention;

FIG. 14 illustrates a representative embodiment of a networked environment for use with some embodiments of the described invention; and

FIGS. 15A-15C illustrate various view of a representative embodiment of the interior design display.

### DETAILED DESCRIPTION OF THE INVENTION

The present invention relates to interior design. In particular, some implementations of the present invention relate to systems and methods for providing an interior design display that is configured to help its users choose one or more design elements from one or more interior design styles and to help ensure that the chosen design elements match or otherwise coordinate with each other.

In the disclosure and in the claims, the term style, interior design style, and variations thereof may refer to any known or novel style for interior design, including, without limitation, one or more of the following styles: contemporary, eclectic, classic, chic, shabby-chic, casual chic, cottage, vintage, traditional, American classic, simple, arts and crafts, French, country French, country, modern, rustic, futuristic, transitional, Tuscan, retro, world flair, south western, spacious, Swedish, funky, New York, garden, Asian, cottage, standard, etc.

In the disclosure and in the claims, the term design element may refer to any known or novel flooring (e.g., tile, stone, carpet, rug, linoleum, laminate, wood, resilient flooring, chemical flooring, floor covering, ceramic flooring, etc.), wall covering (e.g., paint, wallpaper, weave, textile, tile, paneling, paper-backed vinyl, stenciling, vinyl coated paper, paper, stone, etc.), cabinetry, countertop (e.g., tile, composite material, ceramic, stone, wood, post-formed plastic laminate, glass, solid surface plastic material, concrete, silica mineral, metal, resin, compressed paper or fiber, cultured material, etc.), window covering (e.g., drapes, blinds, etc.), hardware, backsplash, lighting fixtures, plumbing fixtures, molding, appliance, lighting, furniture, construction element, decorative element, and/or other material or element that can be used as part of any interior design scheme.

In the disclosure and in the claims, the term design element samples, sample materials, and variations thereof may refer to any piece, sample, image, and/or graphic of a design element that is displayed by (or in connection with) the described design display. Indeed, in some embodiments, each design element sample actually comprises a piece of a design element (e.g., a physical piece of cabinetry, carpet, countertop, tile, etc.). In some embodiments of the described invention, the terms design element samples, sample materials, and variations may refer to a virtual rendition of one or more design elements (or a piece thereof) on an electronic display. In some embodiments, the terms design element samples, sample materials, and variations thereof may refer to a physical embodiment and/or virtual rendering of a design element.

In the disclosure and in the claims, the term match or matching may refer to a situation in which a person and/or computer (e.g., a professional interior designer) has determined that two or more design elements are compatible, complimentary, coordinating, agreeable, harmonious, and/or aesthetically-pleasing with each other (as opposed to being incompatible, mismatched, clashing, disagreeing, discordant, dissonant, and/or inharmonious with each other).

In the disclosure and in the claims, the term interior space may refer to any suitable residential space, office space, retail space, indoor/outdoor space, outdoor space, and/or other area that can be decorated with design elements. In some instances, however, the term interior space may simply refer to a residential living space.

The following disclosure of the present invention is grouped into two subheadings, namely “INTERIOR DESIGN DISPLAY” and “REPRESENTATIVE OPERATING ENVIRONMENT.” The utilization of the subheadings is for convenience of the reader only and is not to be construed as limiting in any sense.

### Interior Design Display

As mentioned above, the described systems and methods include the use of an interior design display (or design display). While the design display can perform a variety of functions, in some embodiments, it optionally provides individuals with information (e.g., one or more descriptions, images, renderings, characteristics, testimonials, etc.) of or about one or more interior design styles (e.g., contemporary, eclectic, classic, etc.). In some embodiments, the design display allows one or more of its users to select two or more design elements (e.g., flooring types, cabinet types, countertop types, etc.) or design element samples from one or more design styles with the assurance that such elements/samples will match with each other when used in an interior space.

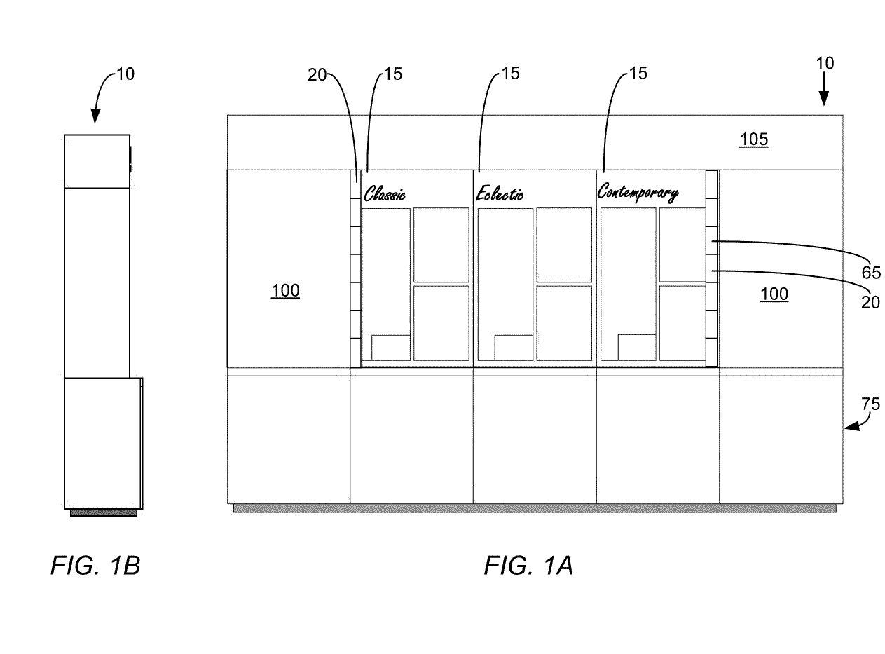

While the described design display can comprise any suitable component or characteristic that allows it to function as intended, FIG. 1A shows a representative embodiment in which the interior design display 10 comprises at least one style display 15 and two or more design element sample collections 20 for each style display, wherein each design element sample collection comprises design element samples (or sample materials) corresponding to a particular style display. To provide a better understanding of the interior design display, each of the aforementioned components is described below in more detail.

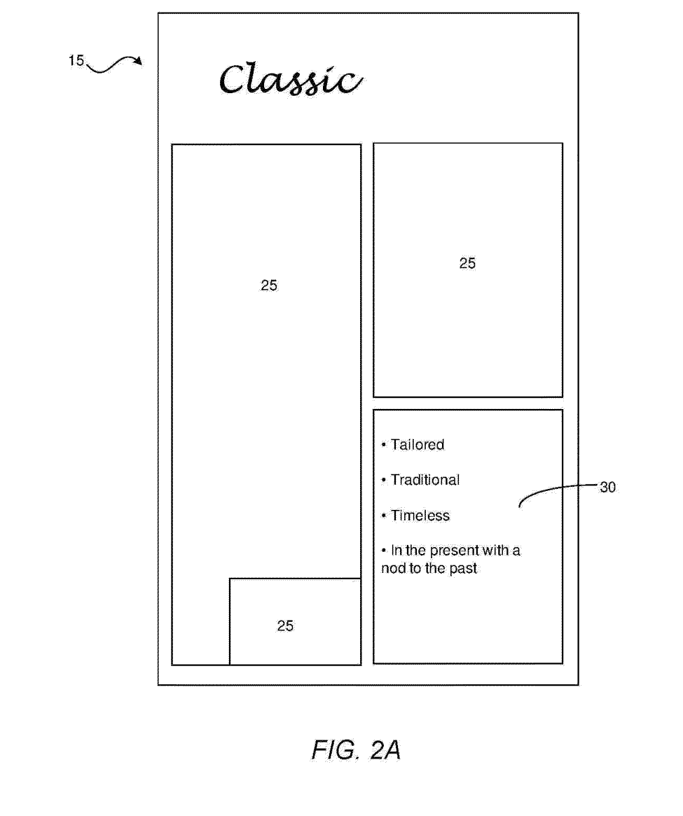

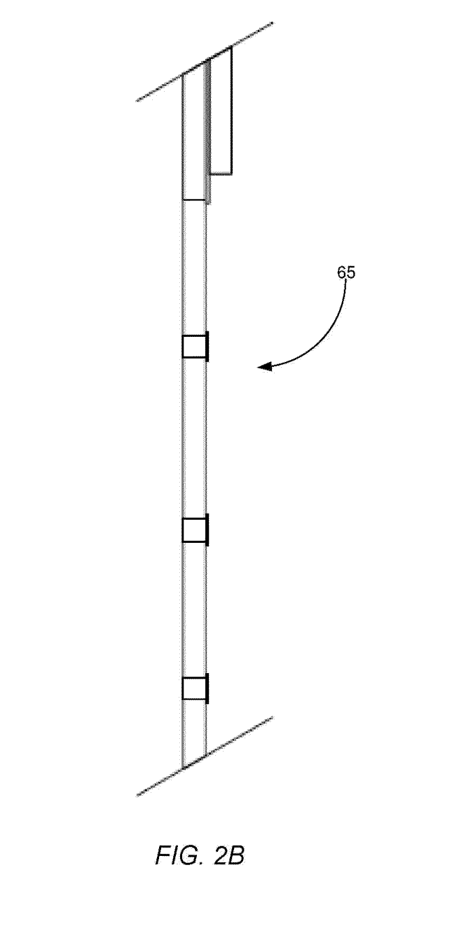

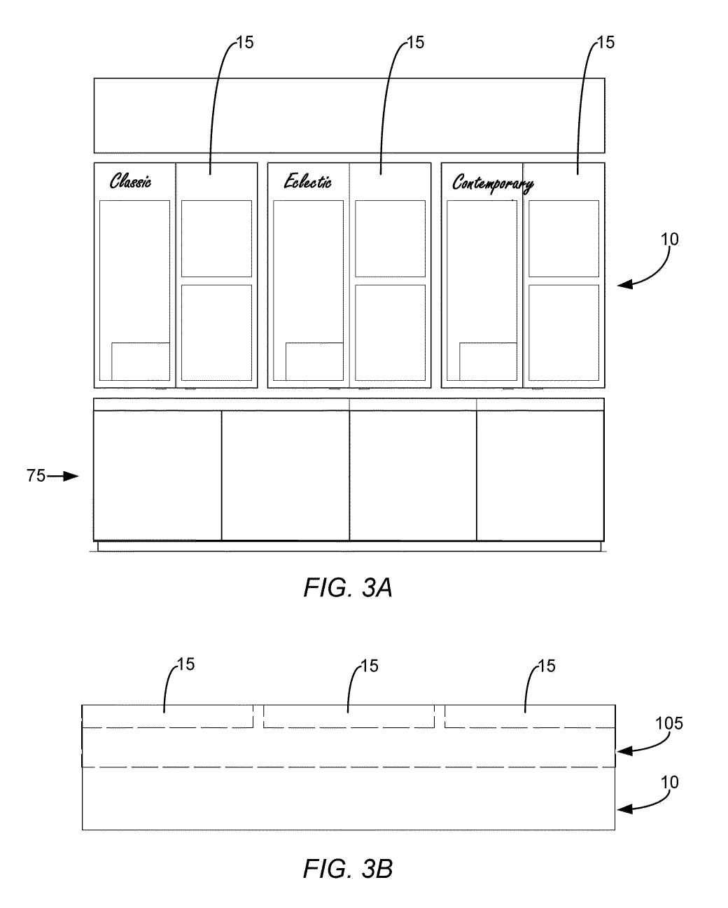

With respect to the style displays 15, the style displays can perform any suitable function, including, but not limited to, identifying one or more particular interior design styles (e.g., classic, eclectic, contemporary, and/or one or more other styles that are provided by a particular builder, designer, vendor, etc.), illustrating the application of a particular style to an interior space, providing an aesthetically-pleasing/advertising aspect to the display 10, and/or to otherwise providing information about a particular style. Additionally, while the style displays can comprise any suitable element (e.g., graphics, lettering, a description of a particular style, testimonials, etc.), FIG. 2A shows an embodiment in which the style display 15 includes multiple graphics 25 (e.g., pictures (not shown) depicting the application of design elements from a particular style, namely the classic style, to one or more interior spaces) and a short listing 30 of characteristics associated with the style addressed by the style display 15 (e.g., the classic style).

Where the interior design display 10 comprises a style display 15, the design display can comprise any suitable number of style displays, including, without limitation, 1, 2, 3, 4, 5, 6, 7, 8, or more. In some embodiments, however, the interior design display 10 comprises 2 or more style displays. By way of non-limiting illustration, FIGS. 3A and 3B show some embodiments in which the design display 10 comprises 3 style displays 15.

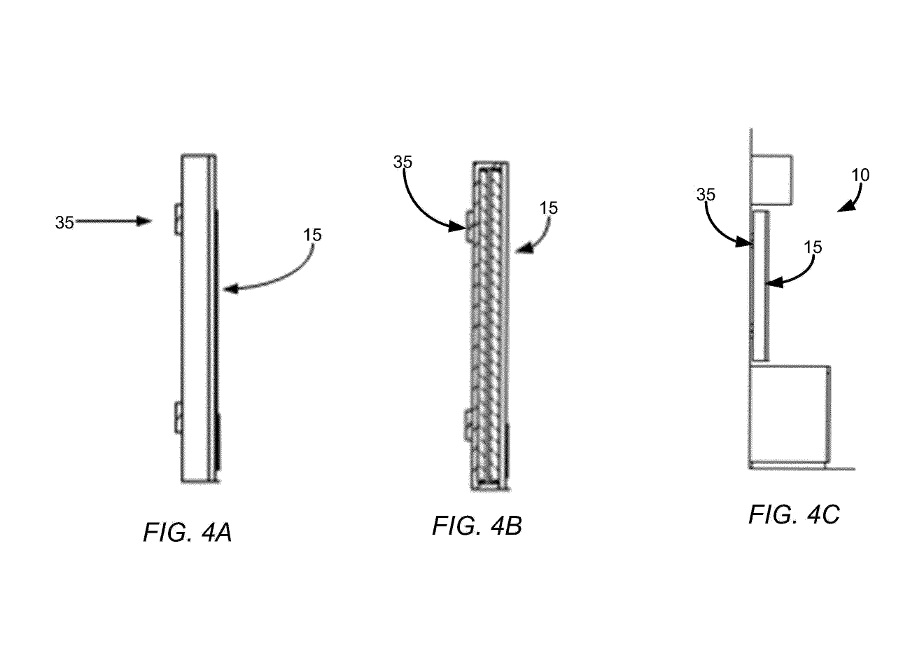

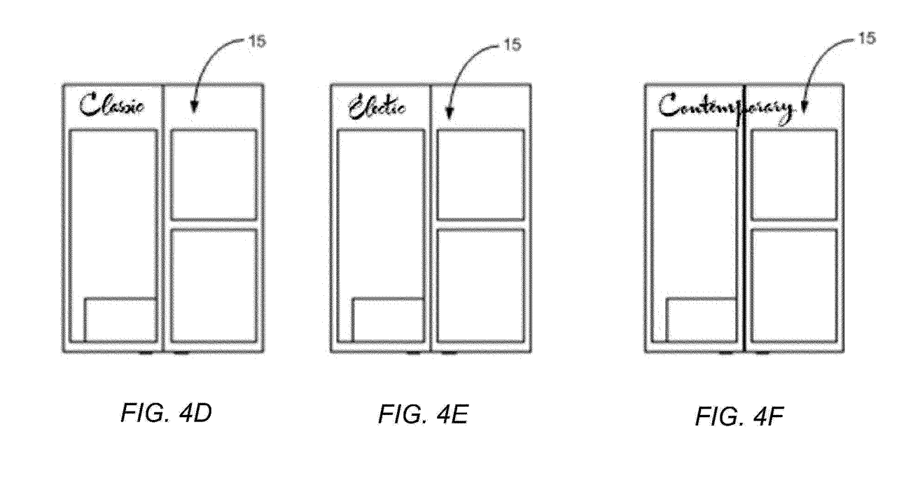

In some embodiments, each style display 15 is stationary with respect to the interior design display 10. In other embodiments, one or more style displays are movable in position with respect to the design display. In some embodiments, however, the style displays are selectively releasable from the interior design display. Thus, in some such embodiments, the style displays can be removed to be updated, modified, interchanged with other style displays, and/or otherwise changed.

Where the style displays 15 are selectively releasable from the interior design display 10, the style displays can attach to (or otherwise be physically associated with) the interior design display in any suitable manner, including, without limitation, through the use of one or more fasteners (e.g., screws, pins, clips, nails, rivets, hook-and-loop fasteners, etc.), mechanical engagements, frictional engagements, rails, slides, glides, tracks, and/or other suitable attachment mechanisms. FIGS. 4A-4B show that, in some embodiments, the style display 15 attaches to (or is physically associated with) the interior design display 10 through the use of one or more French cleats 35.

With respect now to the design element sample collections (or sample collections) 20 corresponding to each of the style displays 15, the described design display 10 can comprise any suitable number of sample collections, including, without limitation, 1, 2, 3, 4, or more for each style display. In this manner, individuals using the interior design display can see and (in some cases) feel a variety of design elements samples (e.g., pieces of flooring, cabinetry, wall covering, countertops, etc.) that are offered in connection with a corresponding style.

While each style display 15 can be associated with any suitable number of corresponding design element sample collections 20, in some embodiments, the interior design display 10 comprises two or more classifications of sample collections for each style display. In this regard, the various classifications of sample collections for each style that is addressed by the design display can be divided in any suitable manner (including, without limitation, as belonging to a warm or a cool color palette, a light or a dark color palette, etc.; as comprising solid colors or mixed colors; and/or in any other manner in which design element samples from one classification (e.g., corresponding to one or more styles) can be determined to match with each other and such that design element samples from another classification (e.g., corresponding to one or more styles) can be determined to match with each other). In some embodiments, however, the design element samples corresponding to a particular style are divided into two classifications, namely: (a) those of a warm color palette or warm classification comprising design element samples that predominantly include colors from a warm color palette (as such term is understood in the art, including, without limitation, a color palette containing hues from red through yellow with browns and tans included) and (b) those of a cool color palette or cool classification comprising design element samples that predominantly include colors from a cool color palette (as such term is understood in the art, including, without limitation, a color palette containing hues from blue green through blue violet, with most greys included).

In some embodiments in which the interior design display 10 comprises two or more classifications of sample collections for each style display 15 (or style addressed by the design display), all of the design element samples in each classification match with each other. Indeed, in some embodiments, all of the design element samples from a collection with a warm classification (or any other suitable type of classification), from either a single style or from multiple styles (e.g., all styles) addressed at the design display, match with each other. Similarly, in some embodiments, all of the design element samples from a collection with a cool classification (or any other suitable type of classification), from either a single style or from multiple styles (e.g., all styles) addressed by the design display, match with each other.

Where design element samples within a particular classification (e.g., a warm or a cool classification) match with each other, the various design element samples in a given classification can be matched with each other in any suitable manner, including, without limitation, by being selected by one or more professional interior decorators, people qualified to match design elements, and/or computer programs to ensure that all of the design element samples (and hence design elements) in a given classification (and collection or collections) match with each other.

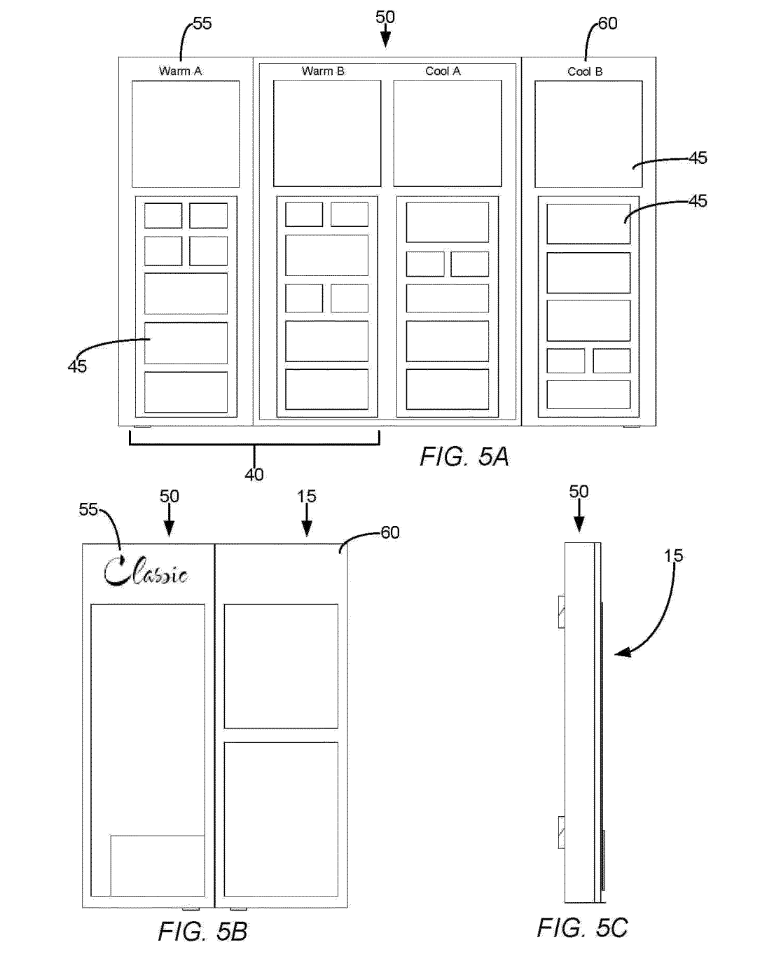

Thus, in some embodiments, an individual (e.g., a customer or other person) selecting design elements from a specific classification (e.g., a warm or cool classification) of sample collections from a particular style can be sure that every combination of design elements that individual selects from that classification will match with each other. Moreover, in other embodiments, an individual selecting design elements from a specific classification (e.g., a warm or cool classification) of sample collections from any or all styles addressed by the design display 10 can be sure that every combination of design element samples (and hence design elements) that the individual selects from that classification will match with each other. In other words, in some embodiments, as long as an individual selects design elements samples from a particular classification (e.g., either the warm or the cool classification), that individual can select design elements from any of the styles offered at the interior design display with the assurance that all such design elements will match. Accordingly, the described interior design display can allow a person (e.g., a person with no particular skill in matching) to easily select two or more design elements from a particular classification (e.g., a warm or cool classification) and even from multiple design styles, without the worry of making a mistake and mismatching design elements.

Where the interior design display 10 comprises two or more design element sample collections 20 (e.g., of a warm and a cool classification) for each style display (or each style addressed by the interior design display), the various collections can be further subdivided in any suitable manner, including, without limitation, into any suitable number of subcategories based on price, subcategories showing different options (e.g., marble vs. granite, etc.), and/or on any other suitable criteria. By way of non-limiting illustration, FIG. 5A shows a representative embodiment in which a specific collection 40 of design element samples 45 is subdivided into Warm A and Warm B subcategories. In this illustration, the Warm A and Warm B subcategories can simply show different options (e.g., design elements from different price ranges, with differing color schemes, etc.) that are available in a given collection (e.g., a warm classification) corresponding to a particular style (e.g., classic, eclectic, contemporary, etc.). In some embodiments, the various design element samples from each of the subcategories from any given classification (e.g., a warm or a cool classification) and from one or more different styles match with each other.

The various collections 20 (and 40) of design element samples 45 can be attached to or otherwise associated with the interior design display 10 in any suitable manner that allows an individual to view, touch, and/or otherwise interact with such sample materials. Indeed, in some embodiments, the design element samples are included in or on one or more cabinets, shelves, panels, walls, and/or other support structures that are associated with the interior design display. In one non-limiting illustration, FIGS. 5A-5C illustrate some representative embodiments in which one or more design element samples 45 are disposed within a cabinet 50 of the interior design display. More particularly, FIGS. 5A-5C show a representative embodiment in which the design element samples 45 are included within a style display 15 that opens to reveal the various design element samples 45. Where design element samples for a specific style and classification are held in a cabinet (e.g., a style display), the cabinet can have any suitable characteristic that allows it to hold the various design element samples. For instance, FIGS. 5A-5B show an embodiment in which a cabinet 50 has two doors 55 and 60. That said, such a cabinet can have any other suitable configuration.

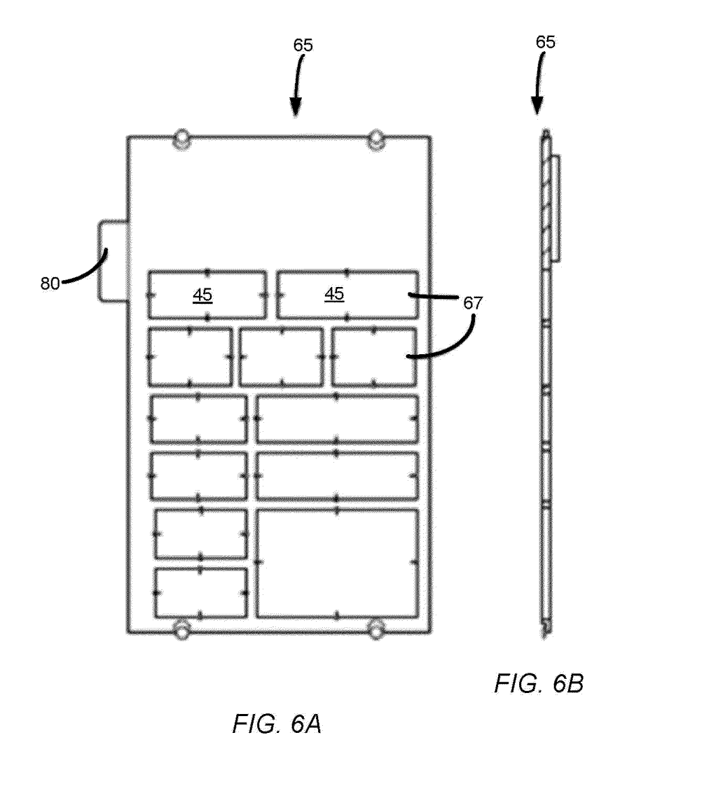

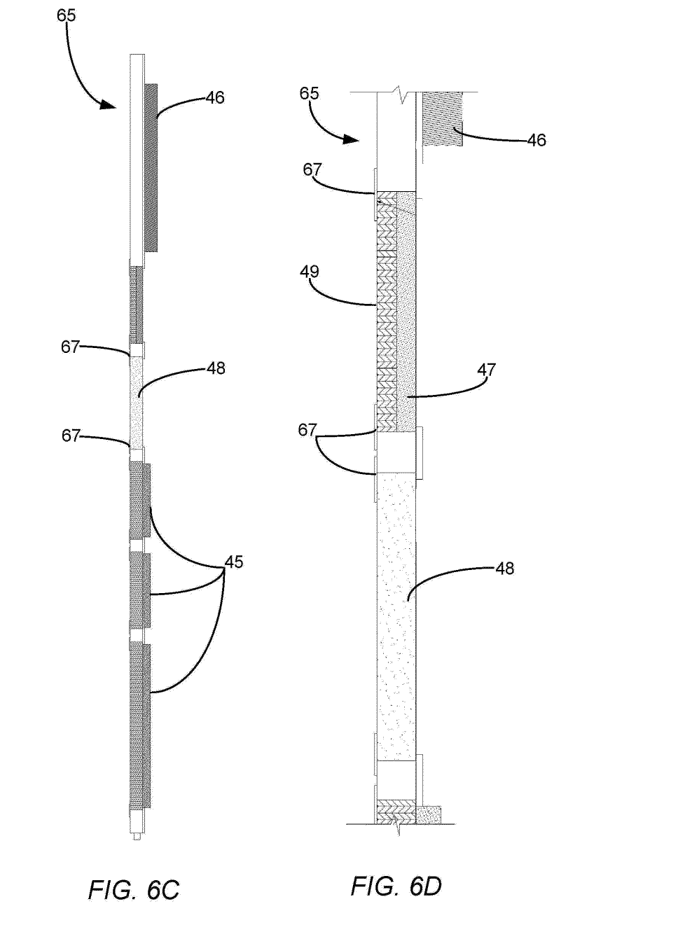

In some embodiments, the various sample collections 20 (and 40) corresponding to the various style displays 15 are disposed on one or more panels. In such embodiments, the various design element samples 45 can be attached to the panels in any suitable manner, including, without limitation, through the use of one or more mechanical fasteners (e.g., frame clips, French cleats, rails and clasps, hook and loop fasteners, etc.), shelves on or recesses in the panel, adhesives, magnets, pockets, linkages (e.g., a cord, chain, etc.), rails, and/or other suitable attachment mechanism. By way of non-limiting illustration, FIG. 6A illustrates a representative embodiment in which design element samples 45 are attached to a sample panel 65 through the use of a plurality of frame clips 67 that twist to release and secure design element samples. In another example, FIGS. 6C and 6D show some embodiments in which a design element 46 (e.g., a piece of a countertop, cabinet, flooring, etc.) is surface mounted on a panel 65, while additional design elements 47 (e.g., backsplash tile, carpet, etc.), 48 (e.g., a countertop sample, etc.), and a depth backer 49 (e.g., backer board) are selectively and releasably received within the panel via frame clips 67. In some such embodiments in which one or more of the design element samples on a sample panel is selectively attachable to and removable from the panel, such design element samples can be removed to be handled by an individual, replaced, updated, and/or otherwise changed.

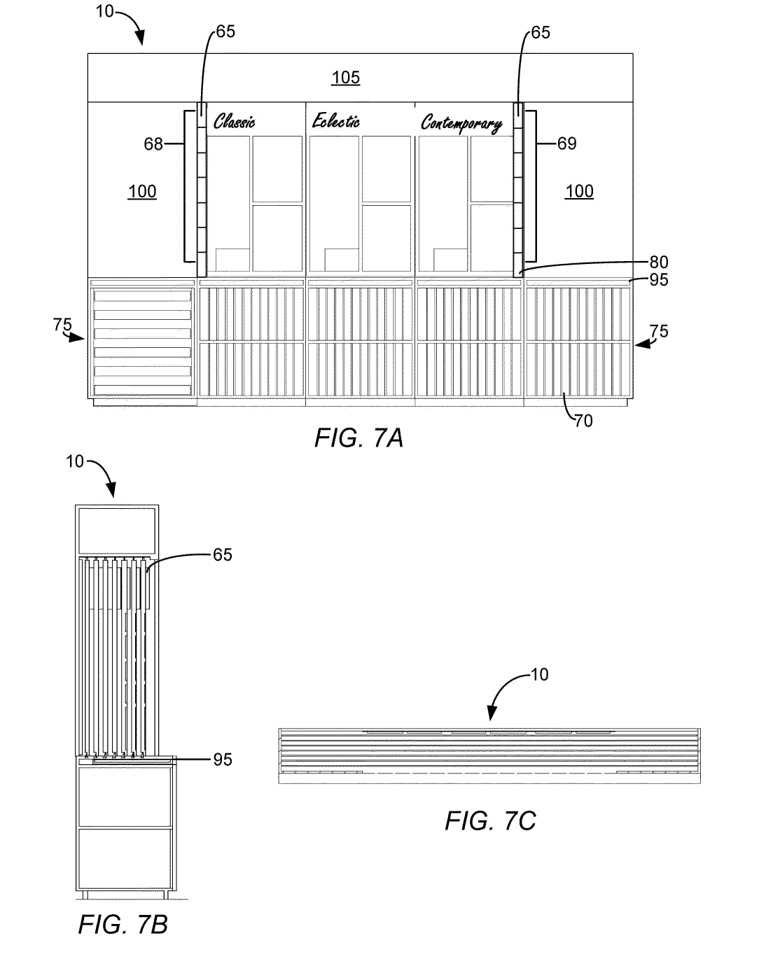

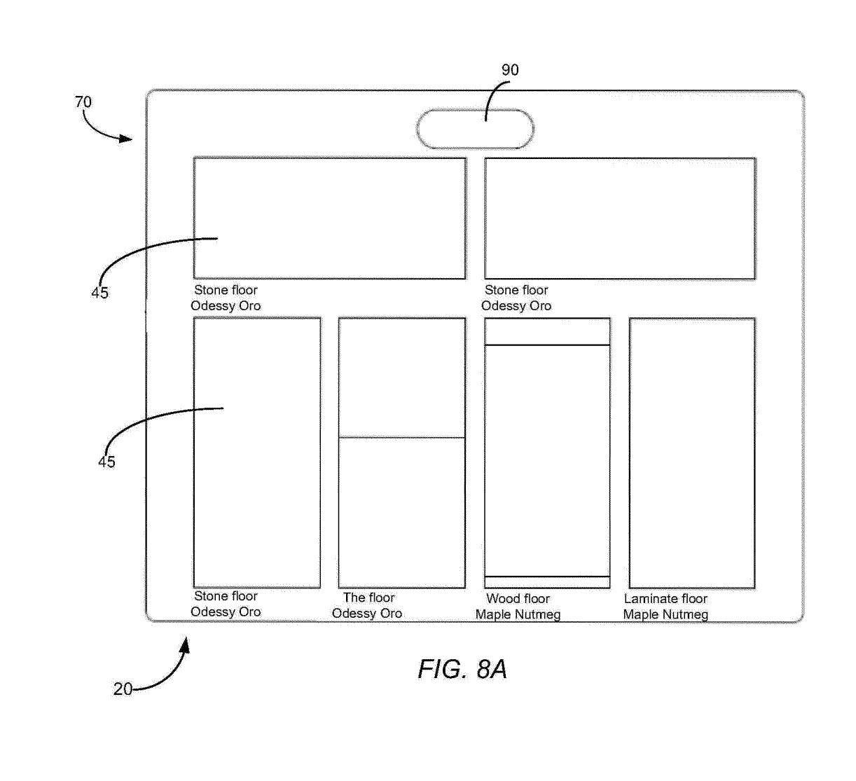

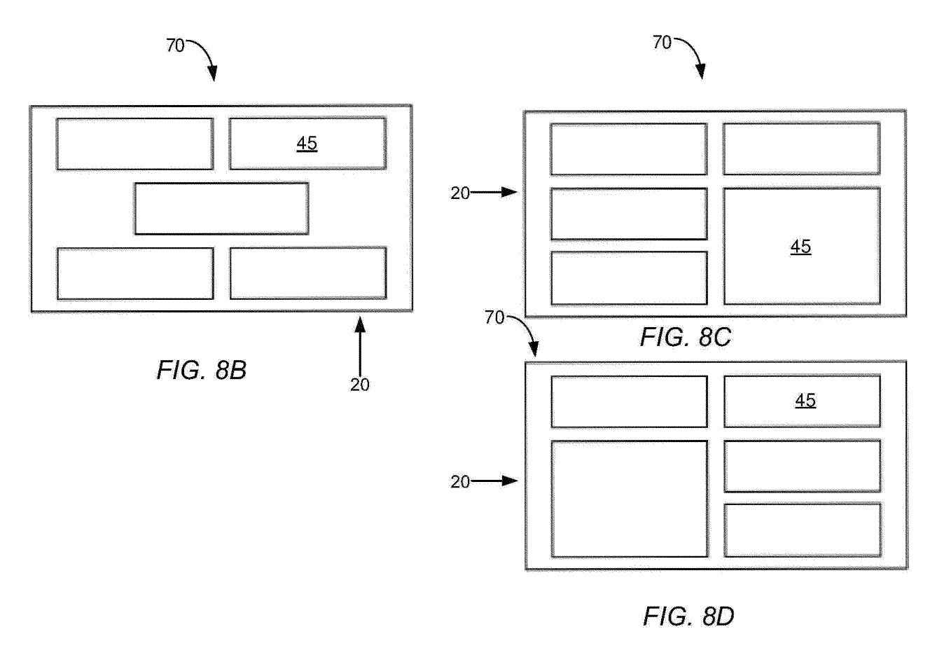

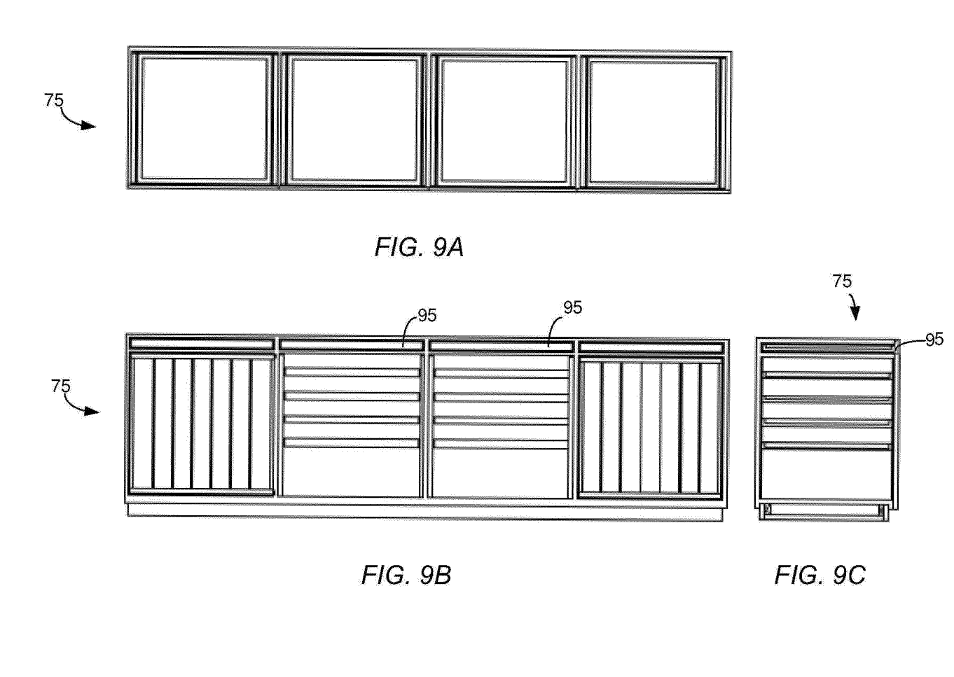

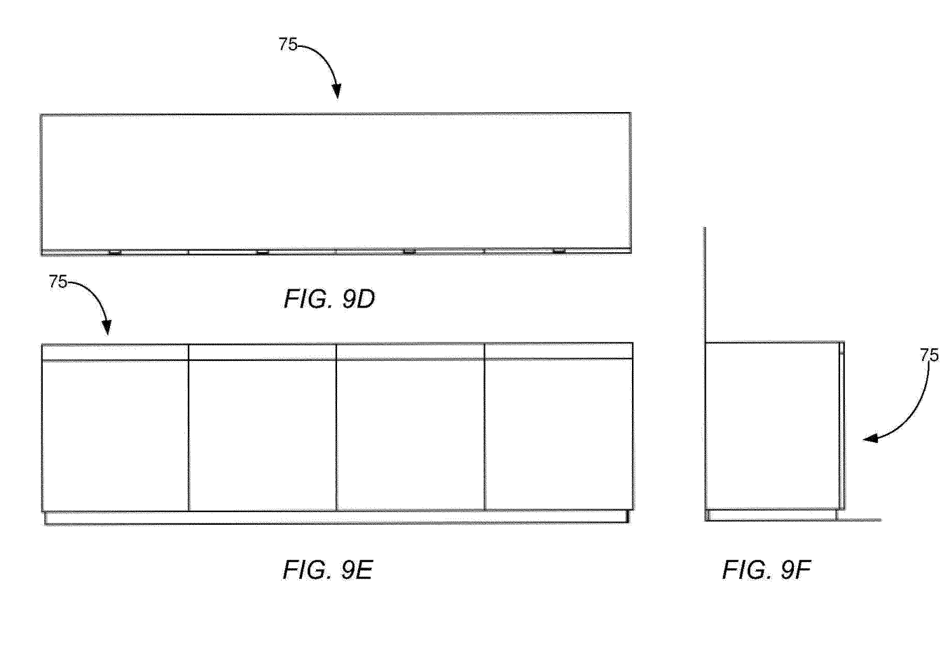

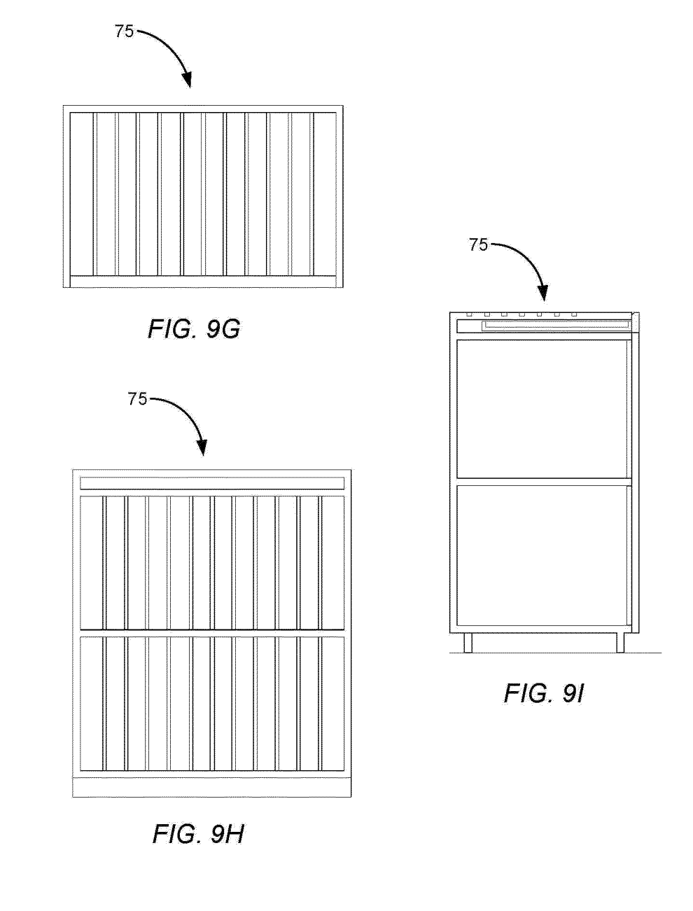

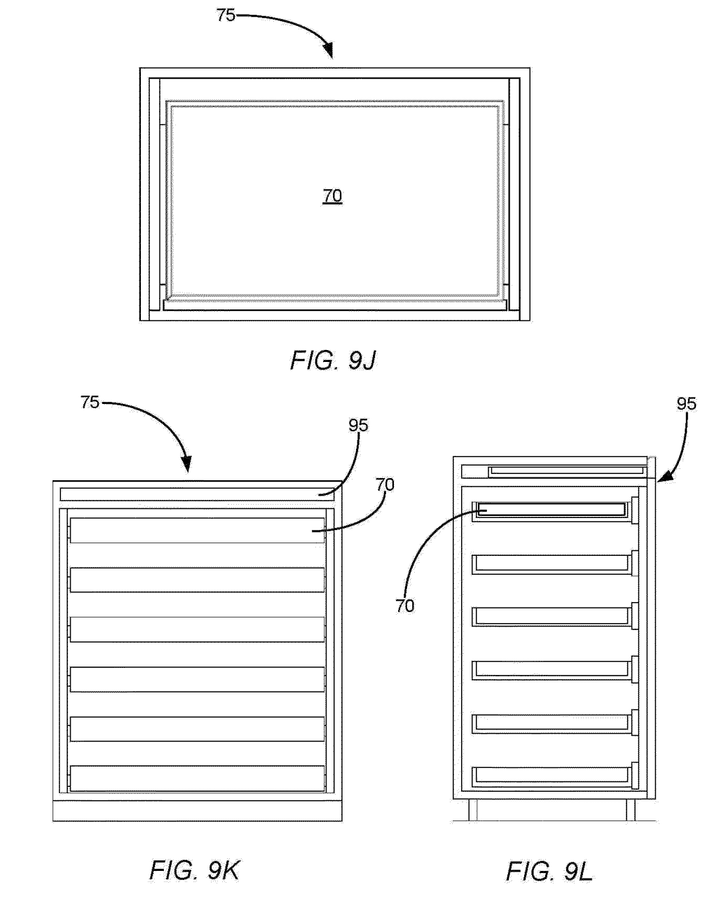

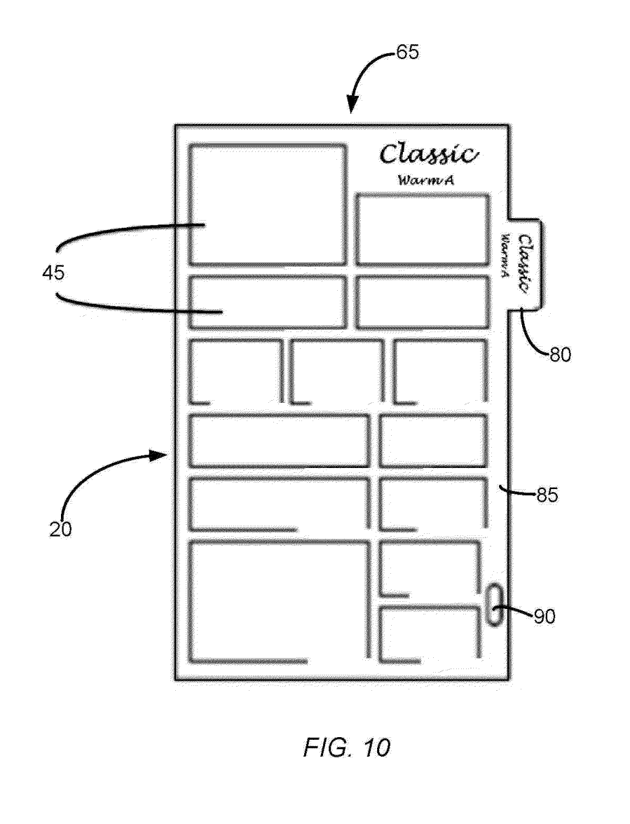

Although, in some embodiments, the sample panels 65 are fixed with respect to the design display 10, in other embodiments, the sample panels are movable with respect to the design display, thus allowing an individual to quickly view a variety of collections (e.g., collections from warm and cool classifications) of design element samples 45 from a variety of interior design styles. Where the sample panels are moveable with respect to the interior design display, the panels can be moveable in any suitable manner that allows an individual to move a sample panel to get a better view of (or to otherwise access) the design element samples disposed thereon. Indeed, in some embodiments, one or more sample panels are configured to: slide or otherwise move horizontally and/or vertically with respect to the design display; to move distally and proximally with respect to the user; to rotate about an axis (e.g., to rotate about an axis within the individual panels; about a carousel; about a hinge, etc.); and/or to otherwise move. In one example, FIG. 7A shows an embodiment in which the various sample panels 65 are configured to slide horizontally (e.g., from right to left and vice versa) within the design display 10. In another example, FIGS. 7A and 9A-11 show some embodiments in which a sample board 70 (e.g., as shown in FIGS. 8A-8D) is configured to be stored in a receptacle (e.g., a cupboard 75, drawer, slot, and/or virtually any other suitable storage space associated with the design display). For instance, when there are more design element samples 45 for a given collection (e.g., a particular warm or cool classification) corresponding to a given style (e.g., a classic or other style) than fit on a sample panel 65, or when there are large samples that do not fit well on the sample panel, FIGS. 8A-8D and 9A-9L show that, in some embodiments, such design element samples 45 can be attached to a sample board 70, which can be stored in one or more cabinets 75 and/or other repositories. In some such embodiments, design element samples corresponding to a certain classification (e.g., a work or a cool classification) match with other sample elements from the same classification (even if such samples correspond to different styles of interior design).

Where the interior design display 10 comprises movable sample panels 65, the sample panels can be stored in any suitable location. In some embodiments, however, the design display is configured such that collections 20 of design element samples from a first classification (e.g., a warm classification) are stored on a first side of the design display while collections of design element samples from a second classification (e.g., a cool classification) are stored on a second side of the design display. By way of non-limiting illustration, FIG. 7A shows an embodiment in which sample panels 68 from a warm color palette (e.g., Warm A, Warm B, etc.) are stored on the left side of the design display 10, while sample panels 69 from a cool color palette (e.g., Cool A, Cool B, etc.) are stored on the right side of the design display 10. (See also FIG. 5A). In such embodiments, an individual can pick a variety of design element samples 45 from either the right or the left side of the design display without worry of making a design faux-pas (mismatching design elements).

Where the design display 10 comprises moveable sample panels 65 and/or sample boards 70, the panels and boards can have any suitable component that allows them to display design element samples 45 (as described herein). Indeed, FIG. 10 shows that, in some embodiments, the sample panels 65 comprise a tab 80 that identifies the collection and/or classification of design element samples 45 on the sample panel (e.g., Classic Warm A, Classic Warm B, Eclectic Warm A, Eclectic Warm B, Contemporary Warm A, Contemporary Warm B, Standard Warm A, etc.). Additionally, FIG. 10 shows that, in at least some embodiments, the sample panel 65 comprises a frame 85 that covers a portion of the sample panels to hide mounting clips 67 (shown in FIG. 6A) and/or to identify or otherwise provide information about particular design element samples 45. In still another example of a suitable component of the sample panels, some embodiments of such panels include one or more depth backers 49 (as shown in FIG. 6D) to bring a front face of one or more design element samples in the sample panel substantially flush with another sample. In still another example of a suitable characteristic of the sample panels/boards, FIG. 10 shows that, in some embodiments, the panels/boards comprise a handhold 90.

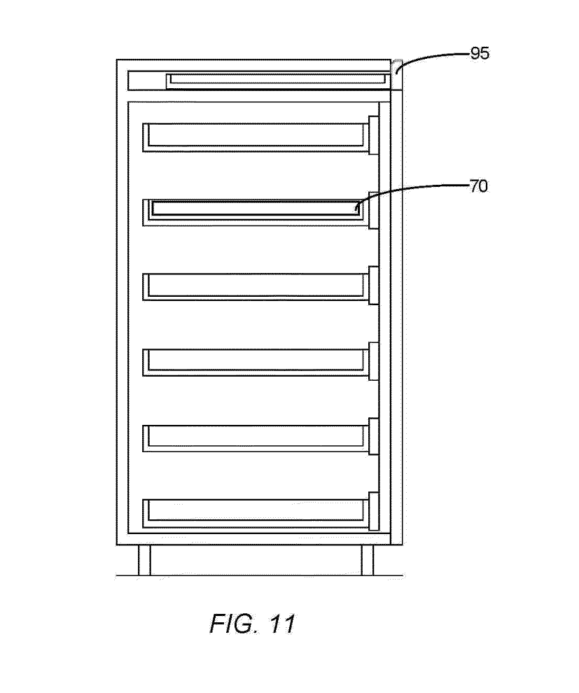

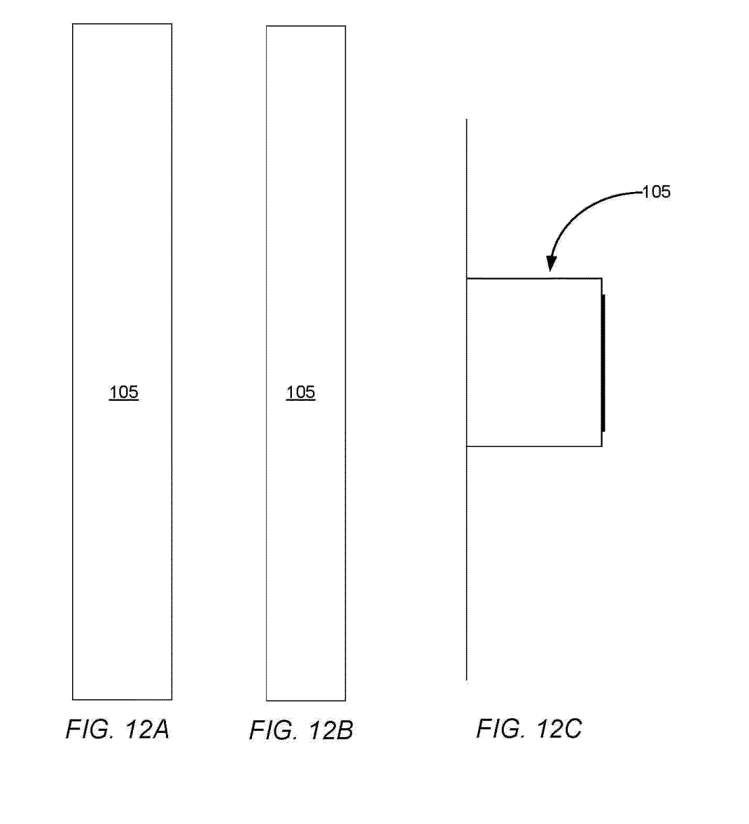

In addition to the aforementioned components, the described design display 10 can comprise any other suitable component that allows it to help one or more users see options for interior design and/or to select matching design elements from one of more interior design styles. Indeed, in some embodiments in which the design display houses one or more sample boards 70, the design display comprises one or more shelves, drawers, or other supports that are configured to hold the sample boards for storage/viewing. By way of non-limiting illustration, FIG. 11 shows a representative embodiment in which a portion of the design display comprises an extendable support or drawer 95 that is configured to hold one or more sample boards for viewing.

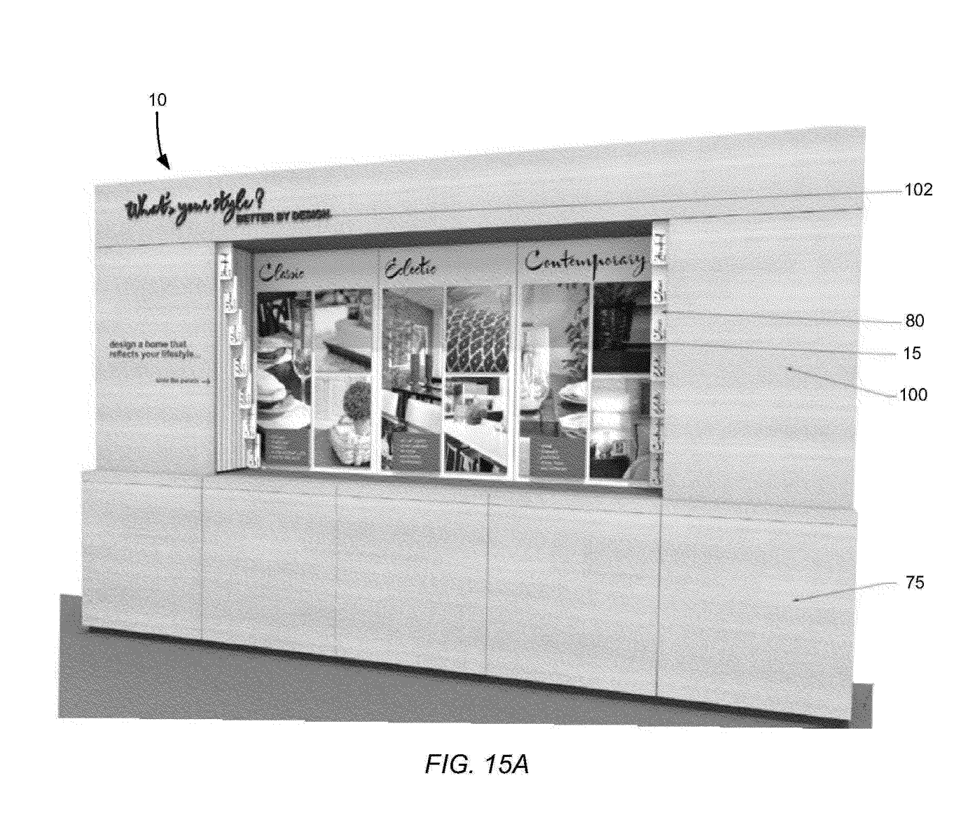

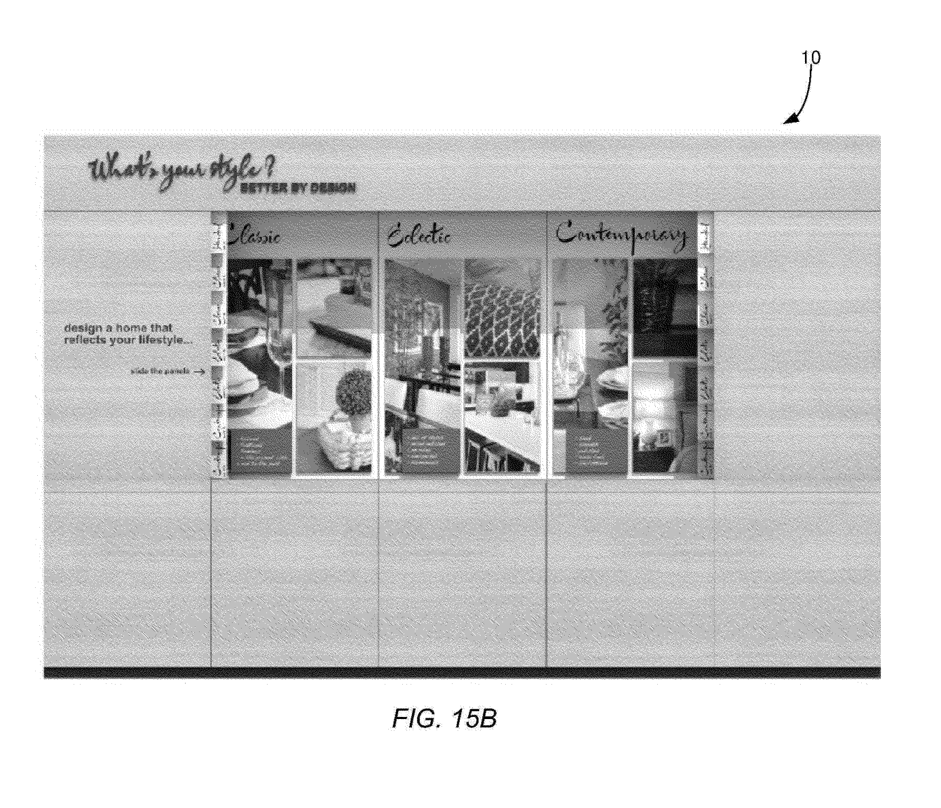

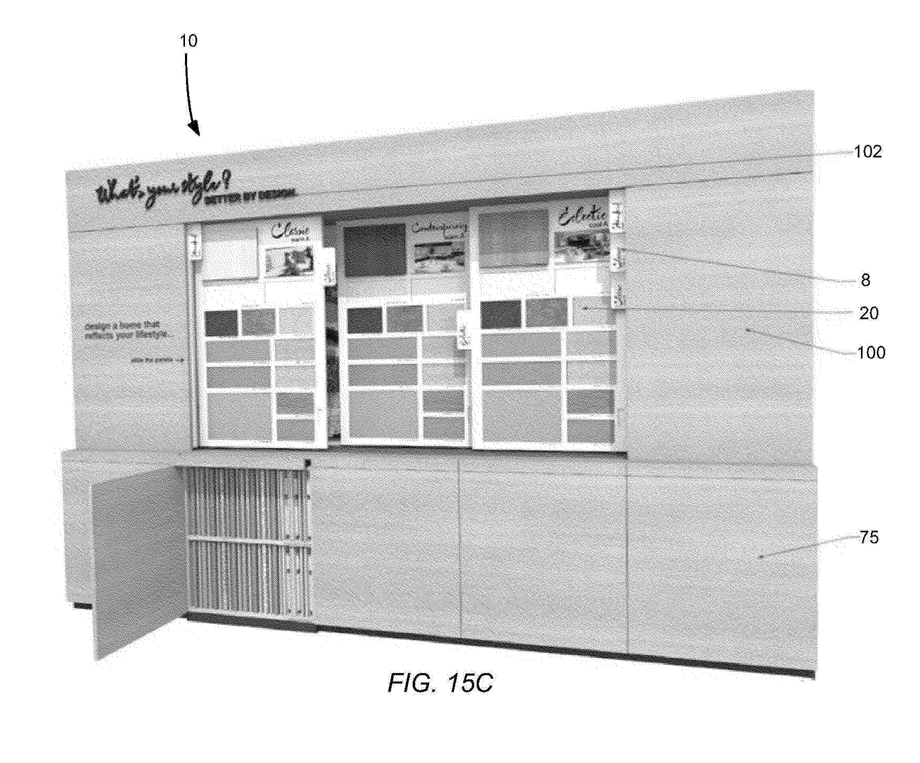

In another example, FIG. 7A shows that, in some embodiments, the design display 10 comprises one or more shrouds 100 to cover the sample panels 65 as they are stored. In still another example, FIG. 7A shows that some embodiments of the design display 10 comprise a header/soffit 105, which can perform a variety of purposes, including, without limitation, housing additional samples; housing lighting to illuminate the style displays 15/sample panels 65; and/or to support rails, guides, and/or other mechanisms that allow the sample panels to slide or otherwise move with respect to the design display. In yet another example, FIG. 15A shows an embodiment in which the display comprises signage, lettering, an identifying mark, or any other suitable decoration 102.

The described interior design display 10 can be made in any suitable manner, including, without limitation, through sawing, cutting, drilling, bending, molding, extrusion, printing, attaching with fasteners, attaching with adhesives, and/or in any other suitable manner. Additionally, the interior design display can comprise any suitable material that allows it to function as intended. For instance, the interior design display, the style displays 15, the sample panels 65, cabinets 75, the sample boards 70, etc. can comprise wood, metal, display board, tile backer board, low pressure laminate, high pressure laminate, polymer, plastic, moderately expanded closed cell polyvinyl chloride extruded in homogeneous sheet with low gloss matte surface, and/or any other suitable material.

The described interior design display 10 can be modified in any suitable manner. Indeed, in some embodiments, the a single style display 15 comprises information regarding multiple styles (e.g., classic and traditional, contemporary and eclectic, and/or any other combination). In other embodiments, instead of having a style display that is separate from the corresponding design element sample collection(s), the style display and corresponding collection are combined. In this regard, the style display and its corresponding collection(s) can be combined in any suitable manner (e.g., by including information about a particular style on sample panel). In still other embodiments, the design display lacks a style display for one or more of the sample collections provided in connection with the design display.

In another example of how the current systems and methods can be modified, in some embodiments, the design display 10 comprises a computer device (e.g., computer device 110, as discussed below) and/or one or more electronic displays (e.g., computer monitors, touchscreen displays, projectors, handheld devices, interactive whiteboards, etc.). While such electronic displays can perform any suitable function, in some embodiments, the electronic displays show (and/or provide information on) a variety of interior design styles, show (and/or provide information about) a variety of design elements/design element design element samples, allow users to see a virtual rendering in which one or more design elements are applied to particular interior space (e.g., the model home in which the design display is disposed, an interior space being designed for a consumer, etc.), and/or to otherwise help a user choose design elements that match.

In some embodiments, in which the interior design display 10 comprises an electronic display, the electronic display can perform any suitable function, including, without limitation, those functions of the style displays that are discussed above. Indeed, in some embodiments, each electronic style display shows a variety of photos, video footage, illustrations, graphics, specifications, pricing, virtual renderings, comments, and/or other information relating to one or more interior design styles. In this regard, while the design display 10 can comprise any suitable number of electronic style displays and can further include at least one electronic style display for each style that is addressed at the interior design display, in some embodiments, the design display comprises a single electronic display that is capable of showing a virtual rendering of each style display for each interior style that is addressed by the design display.

Although in some embodiments in which the style displays 15 are shown on one or more electronic displays, the interior design display 10 also comprises one or more physical sample collections 20 and/or physical design element samples 45 (e.g., portions of carpet, tile, etc.) corresponding to one or more of the style displays shown on the electronic style display (or otherwise associated with the design display), in other embodiments, a portion (if not all) of the sample collections and/or design element samples available for viewing at the interior design display are shown via an electronic display. Although in some such embodiments, the sample collections and/or design element samples are shown on separate electronic displays than the style displays, in other embodiments, the sample collections and/or design element samples are shown on the same electronic display (or displays) as are their corresponding style displays.

In embodiments in which the style displays 15 are shown on the same electronic display as the corresponding sample collection(s) 20 and/or design element samples 45, the interior design display 10 can function in any suitable manner. Indeed, in some embodiments in which the design display comprises an electronic display, a user can view one or more of a variety of style displays (e.g., a style display of a contemporary style, an eclectic style, a classic style, etc.) on the electronic display. In some such embodiments, the user is further able to select a particular interior design style, wherein such selection can occur in any suitable manner, including, without limitation, by touching a portion of the electronic display (e.g., where the electronic display comprises a touchscreen device), clicking a mouse, pressing a button, moving one or both of the user's hands, moving the user's eyes, operating a remote control, and/or any other suitable selection technique.

In some embodiments in which the described design display 10 comprises one or more electronic displays, the design display further allows its users to use the electronic display to see one or more sample collections 20 (e.g., from a warm and/or cool color palette classification) corresponding to the selected style (or styles). While the described design display can place images and/or other information on each of the sample collections and/or design element samples 45 in any suitable location on the electronic display, in some embodiments, the design element samples are placed on opposite sides of the electronic display, based upon the classification of the materials. Indeed, in some embodiments, design element samples having a warm classification (e.g., Warm A, Warm B, etc.) and belonging to one or more interior design styles are shown on one side of the electronic display (e.g., a top, bottom, left, or right side), while design element samples having a cool classification (e.g., Cool A, Cool B, etc.) and belonging to one or more interior styles are shown on an opposite side of the electronic display. In such embodiments, a user can select design element samples from one or more styles that are shown on one side of the electronic display with confidence that all design element samples from that side (e.g., a warm or cool side) of the electronic display will match.

In some embodiments, instead of placing the various classifications of design element samples 45 on different sides of an electronic display (and/or physical display, as discussed above), the design elements samples of a particular classification are otherwise distinguished from design element samples of another classification. In this regard, the various classifications (e.g., warm and cool) can be distinguished from each other by being marked differently (e.g., by being labeled with a classification through writing, use of a color or symbol associated a specific classification, and/or by otherwise being differentiated from each other), by being made accessible from different locations (e.g., being accessible through different drop down menus, on different windows, on different webpages, and/or by otherwise distinguishing the various classifications through placing the various classifications in different locations (e.g., virtually and/or physically).

The described interior design display 10 can be used in any suitable manner that allows it to help users select a variety of matching design elements. In some implementations, the design display (e.g., a display with physical design element samples, an electronic display, and/or any other suitable component or characteristic) is disposed in a store (e.g., an interior design store, hardware store, home furnishing store, etc.), a model home, and/or any other suitable location. Additionally, in some embodiments, the design display comprises one or more style displays 15 and/or design element samples 45 that correspond to style options that are provided by a particular interior designer, contractor, home builder, retailer, etc. In this manner, the design display can allow its users to quickly view and/or touch a variety of design element samples from a variety of classifications (e.g., warm and cool) and from a variety of available interior design styles. As a result, a user can easily select design elements corresponding to one or more styles, and always have such elements match, as long as the corresponding design elements were selected from the same classification (e.g., a warm or a cool classification).

In another example of how the described design display 10 can be used, in some embodiments, the design display is available over the Internet, an intranet, as a software program, as an application for a computer device (e.g., a smartphone, tablet, personal digital assistant “PDA”, etc.), and/or in any other suitable electronic format. Indeed, in some cases, a user is able to access the interior design display through a software application (e.g., on the user's smartphone, tablet, etc.) that allows the user to view a variety of design displays 15 (e.g., virtual design displays), view a variety of sample collections 20 (e.g., virtual sample collections), view design element samples 45 (e.g., images of design elements and/or physical design element samples) from one or more classifications (e.g., warm and/or cool), select one or more design element samples (knowing that design element samples from the same classification will match with each other (in some embodiments, even if the samples are from a different sub-classifications, such as Warm A and Warm B), and/or view a rendering of the selected design element samples in an interior space (e.g., a picture of an interior space that was uploaded by the user). Thus (and as described above), the described design display can allow its users to select a variety of matching design elements from one or more interior design styles.

### Representative Operating Environment

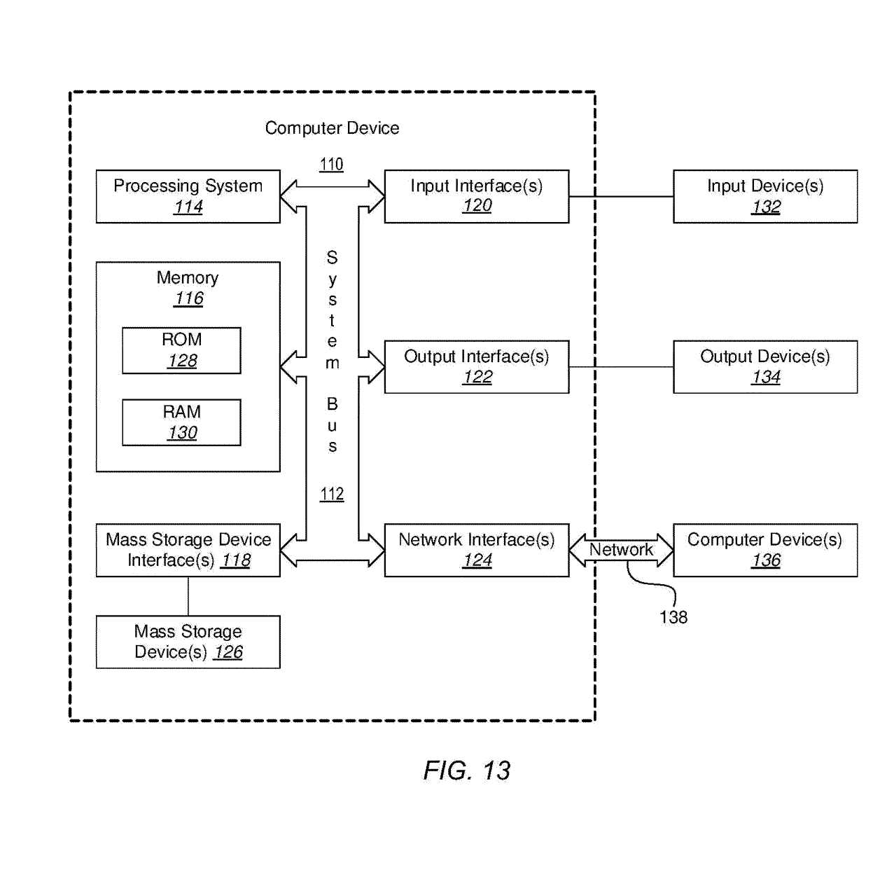

FIG. 13 and the corresponding discussion are intended to provide a general description of a representative embodiments of a suitable operating environment in which one or more embodiments of the interior design display 10 may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 13, a representative system for implementing the invention includes computer device 110, which may be a general-purpose or special-purpose computer. For example, computer device 110 may be a personal computer, a notebook computer, a PDA or other hand-held device, a workstation, a minicomputer, a mainframe, a supercomputer, a multi-processor system, a network computer, a processor-based consumer electronic device, or the like.

Computer device 110 includes system bus 112, which may be configured to connect various components thereof and enables data to be exchanged between two or more components. System bus 112 may include one of a variety of bus structures including a memory bus or memory controller, a peripheral bus, or a local bus that uses any of a variety of bus architectures. Typical components connected by system bus 112 include processing system 114 and memory 116. Other components may include one or more mass storage device interfaces 118, input interfaces 120, output interfaces 122, and/or network interfaces 124, each of which will be discussed below.

Processing system 114 includes one or more processors, such as a central processor and optionally one or more other processors designed to perform a particular function or task. It is typically processing system 114 that executes the instructions provided on computer readable media, such as on memory 116, a magnetic hard disk, a removable magnetic disk, a magnetic cassette, an optical disk, or from a communication connection, which may also be viewed as a computer readable medium.

Memory 116 includes one or more computer readable media that may be configured to include or includes thereon data or instructions for manipulating data, and may be accessed by processing system 114 through system bus 112. Memory 116 may include, for example, ROM 128, used to permanently store information, and/or RAM 130, used to temporarily store information. ROM 128 may include a basic input/output system (“BIOS”) having one or more routines that are used to establish communication, such as during start-up of computer device 110. RAM 130 may include one or more program modules, such as one or more operating systems, application programs, and/or program data.

One or more mass storage device interfaces 118 may be used to connect one or more mass storage devices 126 to system bus 112. The mass storage devices 126 may be incorporated into or may be peripheral to computer device 110 and allow computer device 110 to retain large amounts of data. Optionally, one or more of the mass storage devices 126 may be removable from computer device 110. Examples of mass storage devices include hard disk drives, magnetic disk drives, tape drives and optical disk drives. A mass storage device 126 may read from and/or write to a magnetic hard disk, a removable magnetic disk, a magnetic cassette, an optical disk, or another computer readable medium. Mass storage devices 126 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 120 may be employed to enable a user to enter data and/or instructions to computer device 110 through one or more corresponding input devices 132. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 120 that may be used to connect the input devices 132 to the system bus 112 include a serial port, a parallel port, a game port, a universal serial bus (“USB”), a firewire (IEEE 1394), or another interface.

One or more output interfaces 122 may be employed to connect one or more corresponding output devices 134 to system bus 112. Examples of output devices include a monitor or display screen, a speaker, a printer, and the like. A particular output device 134 may be integrated with or peripheral to computer device 110. Examples of output interfaces include a video adapter, an audio adapter, a parallel port, and the like.

One or more network interfaces 124 enable computer device 110 to exchange information with one or more other local or remote computer devices, illustrated as computer devices 136, via a network 138 that may include hardwired and/or wireless links. Examples of network interfaces include a network adapter for connection to a local area network (“LAN”) or a modem, wireless link, or other adapter for connection to a wide area network (“WAN”), such as the Internet. The network interface 124 may be incorporated with or peripheral to computer device 110. In a networked system, accessible program modules or portions thereof may be stored in a remote memory storage device. Furthermore, in a networked system computer device 110 may participate in a distributed computing environment, where functions or tasks are performed by a plurality of networked computer devices.

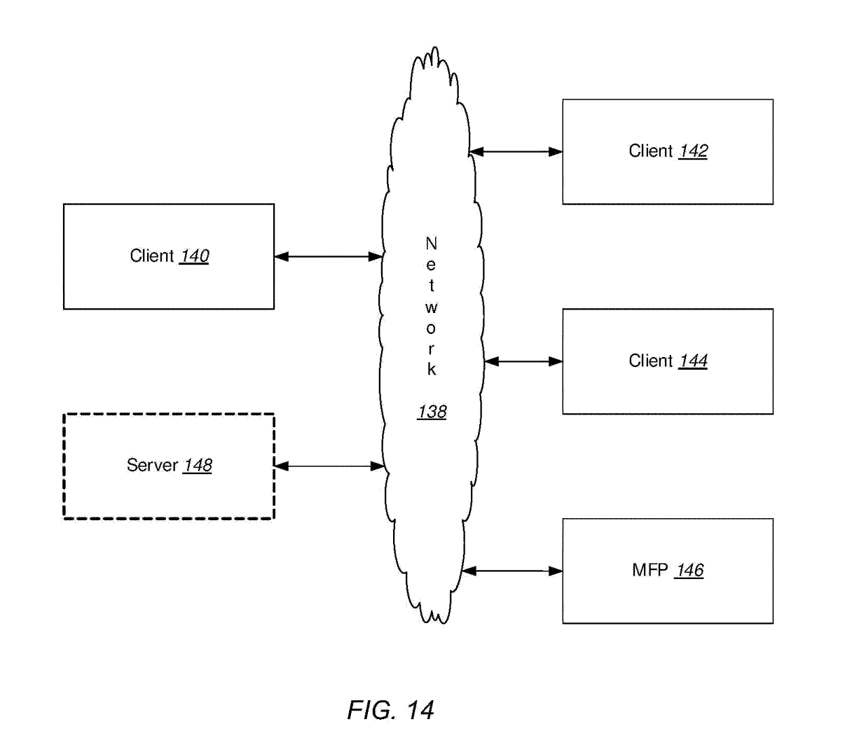

While those skilled in the art will appreciate that the invention may be practiced (as mentioned above) in networked computing environments with many types of computer system configurations, FIG. 14 represents an embodiment of the present invention in a networked environment that includes clients (e.g., 140, 142, and 144) connected to a server via a network. While FIG. 14 illustrates an embodiment that includes three clients connected to the network, alternative embodiments include one or two clients connected to a network or many clients connected to a network. Moreover, embodiments in accordance with the present invention also include a multitude of clients throughout the world connected to a network, where the network is a wide area network, such as the Internet. As a result, in some embodiments, the described interior design display 10 is available (e.g., virtually) over a network (e.g., as discussed above).

Thus, as discussed herein, the embodiments of the present invention embrace the field of interior design. More particularly, some embodiments of the present invention relate to systems and methods for providing an interior design display that is configured to help its users choose one or more design elements from one or more interior design styles and to help ensure that the chosen design elements match or otherwise coordinate with each other.

The present invention may be embodied in other specific forms without departing from its spirit or essential characteristics. The described embodiments and examples are all to be considered in all respects only as illustrative and not as being restrictive in any manner. The scope of the invention is, therefore, indicated by the appended claims rather than by the foregoing description. All changes that come within the meaning and range of equivalency of the claims are to be embraced within their scope.

What is claimed is:

1. An interior design display, comprising:
a first style display comprising information regarding a first style of interior design;
a second style display comprising information regarding a second style of interior design;
a first sample collection comprising design element samples corresponding to the first style of interior design;
a second sample collection comprising design element samples corresponding to the first style of interior design;
a third sample collection comprising design element samples corresponding to the second style of interior design; and
a fourth sample collection comprising design element samples corresponding to the second style of interior design,
wherein the design element samples from the first sample collection corresponding to the first style of interior design match with the design element samples from the third sample collection corresponding to the second style of interior design, and
wherein the design element samples from the second sample collection corresponding to the first style of interior design match with the design element samples from the fourth sample collection corresponding to the second style of interior design.

2. The display of claim 1, wherein the design element samples from the first sample collection corresponding to the first style of interior design are selected from a warm color palette; and wherein the design element samples from the third sample collection corresponding to the second style of interior design are also selected from the warm color palette.

3. The display of claim 1, wherein the design element samples from the second sample collection corresponding to the first style of interior design are selected from a cool color palette; and wherein the design element samples from the second sample collection corresponding to the second style of interior design are also selected from the cool color palette.

4. The display of claim 1, further comprising:
a third style display comprising information regarding a third style of interior design;
a fifth sample collection comprising design element samples corresponding to the third style of interior design; and
a sixth sample collection comprising design element samples corresponding to the third style of interior design,
wherein the design element samples from the fifth sample collection corresponding to the third style of interior design match with the design element samples from the first sample collection corresponding to the first style of interior design, and
wherein the design element samples from the sixth sample collection corresponding to the third style of interior design match the design element samples from the second sample collection corresponding to the first style of interior design.

5. The display of claim 1, wherein the interior design display comprises a cabinet that is configured to hold the first and second sample collections.

6. The display of claim 1, wherein the first and second sample collections are each disposed on a separate movable panel.

7. The display of claim 6, wherein the first sample collection is configured to be stored on a first side of the interior design display while the second sample collection is configured to be stored on a second side of the interior design display.

8. The display of claim 1, wherein the first and second sample collections each comprise a combination of at least two of the following: a flooring sample, a wall covering sample, a cabinetry sample, a countertop sample, a window covering sample, a hardware sample, a backsplash sample, a lighting fixture sample, a plumbing fixture sample, a molding sample, an appliance sample, and a furniture sample.

9. The display of claim 1, further comprising a cabinet configured to house multiple sample boards having at least one design element sample attached to each of the boards.

10. The display of claim 1, wherein the interior design display comprises a computer processor that is configured to display the first style display and the second style display via an electronic display.

11. The display of claim 1, wherein the first sample collection is subdivided into a first subcategory of design element samples and a second subcategory of design element samples.

12. An interior design display, comprising:
a first sample collection comprising a first set of design element samples corresponding to a first style of interior design;
a second sample collection comprising a second set of design element samples corresponding to the first style of interior design;
a third sample collection comprising a third set of design element samples corresponding to a second style of interior design; and
a forth sample collection comprising a fourth set of design element samples corresponding to the second style of interior design,
wherein the first set of design element samples matches with the third set of design element samples.

13. The display of claim 12, wherein the display further comprises a first moveable sample panel, and wherein the first set of design element samples is displayed on the moveable sample panel.

14. The display of claim 13, wherein the display further comprises a second moveable sample panel, wherein the second set of design element samples is displayed on the second moveable sample panel, wherein the display is configured to store the first moveable sample panel at a first side of the display, and wherein the display is configured to store the second moveable sample panel at a second side of the display.

15. The display of claim 12, wherein the first and third set of design element samples each comprise a design element sample comprising a predominant color selected from a warm color palette.

16. The display of claim 12, wherein the second and fourth set of design element samples each comprise a design element sample comprising a predominant color selected from a cool color palette.

17. The display of claim 14, wherein the first and second moveable sample panels are slidable from right to left and vice versa with respect to a portion of the interior design display.

18. A method for providing interior design choices, the method comprising:
providing an interior design display comprising:
a first sample collection comprising a first set of design element samples corresponding to a first style of interior design;
a second sample collection comprising a second set of design element samples corresponding to the first style of interior design;
a third sample collection comprising a third set of design element samples corresponding to a second style of interior design; and
a forth sample collection comprising a fourth set of design element samples corresponding to the second style of interior design,
ensuring that all design element samples from the first and third sets of design element samples match with each other, and
ensuring that all design element samples from the second and fourth sets of design element samples match with each other.

19. The method of claim 17, wherein the first and second sample collections are each moveable from right to left within the display, and wherein the method further comprises moving the first sample collection within the display.

20. The method of claim 17, wherein the first and third set of design element samples each comprise design elements having a predominant color selected from a warm color palette.

21. A computer program product for implementing within a computer system a method for selecting matching design elements, the computer program product comprising:
a non-transitory computer readable medium for providing computer program code means utilized to implement the method, wherein the computer program code means is comprised of executable code for implementing the steps for:
providing an interior design display comprising:
a first sample collection comprising a first set of design element samples corresponding to a first style of interior design;
a second sample collection comprising a second set of design element samples corresponding to the first style of interior design;
a third sample collection comprising a third set of design element samples corresponding to a second style of interior design; and
a forth sample collection comprising a fourth set of design element samples corresponding to the second style of interior design,
ensuring that design element samples from the first and third sets of design element samples match with each other, and
ensuring that design element samples from the second and fourth sets of design element samples match with each other.

22. The computer program product of claim 21, wherein the computer program code means further comprises executable code for implementing a step of displaying a style display comprising information relating to the first style of interior design.

23. The computer program product of claim 21, wherein all design elements from the first and third sets of design element samples comprise a color selected from a warm color palette.
